(19) United States
(12) Patent Application Publication
(10) Pub. No.: US 2025/0298288 A1
(43) Pub. Date: Sep. 25, 2025

(54) TWIN LENSES MANUAL SYNCHRONOUS FOCUSING STRUCTURE

(71) Applicant: Shenzhen Gaodi Digital Co., Ltd., Shenzhen (CN)

(72) Inventor: Zhujun Chen, Shenzhen (CN)

(21) Appl. No.: 18/731,966

(22) Filed: Jun. 3, 2024

(30) Foreign Application Priority Data
Mar. 20, 2024 (CN) 202420556343.5

(51) Int. Cl. G03B 13/34; G02B 7/06; G02B 23/12; G03B 11/04; G03B 15/02

(52) U.S. Cl. CPC G03B 13/34; G02B 7/06; G02B 23/12; G03B 11/041; G03B 15/02

(57) ABSTRACT

The present disclosure relates to a dual lens manual synchronous focusing structure, which can drive the movable frame to move through the manual driving assembly during focusing, while the first rack on the movable frame drives the first outer gear ring to rotate, the second rack drives the second outer gear ring to rotate, the first outer gear ring turns the first lens barrel to rotate, and the first lens barrel is screwing connected with the first base, thus, the first lens barrel is close to or far away from the first photosensitive chip, the second outer gear ring turns the second lens barrel to rotate, and the second lens barrel is screwing connected with the second base, thus the second lens barrel is close to or far from the second photosensitive chip, so that the focusing of the first lens assembly and the second lens assembly can be synchronized.

### CROSS-REFERENCE TO RELATED APPLICATION

This application claims the benefit of priority from Chinese Patent Application No. 202420556343.5, entitled “TWIN LENSES MANUAL SYNCHRONOUS FOCUSING STRUCTURE” and filed on Mar. 20, 2024, the content of which is hereby incorporated by reference in its entire by reference.

### TECHNICAL FIELD

The present disclosure generally relates to the technical field of cameras devices, in particular to a twin lenses manual synchronous focusing structure.

### BACKGROUND

Cameras devices, including telescopes, cameras, VR, and night vision devices, capture images through lens and display images through a display screen for observe. Traditional cameras devices are generally 2D structures, that is, only one lens. With the development of technology, 3D camera devices are becoming more and more popular, especially naked-eye 3D camera devices are welcomed by many consumers. Naked-eye 3D camera devices have twin lenses, and the twin lenses are spaced by papillary distance. Due to the different vistas of the object, the focus of the lens usually needs to be adjusted. The focus of existing 3D camera devices cannot be adjusted, or only can be adjusted through software, that is focusing ability of the existing 3D camera devices is limited, and physical focusing is difficult to achieve. Some products use a method of separate focusing, but by this way it is difficult to maintain the focal length of the twin lenses consistently, resulting in poor 3D effect.

### SUMMARY

In view of the above situation, it is necessary to provide a twin lenses manual synchronous focusing structure that can physically focus the lenses.

In order to solve the above technical problems, the technical scheme adopted by the present disclosure is a twin lenses manual synchronous focusing structure, used on a camera device; the camera device includes a first lens assembly and a second lens assembly spaced arranged with the first lens assembly; the first lens assembly includes a first base, a first photosensitive chip and a first lens barrel; the second lens assembly includes a second base, a second photosensitive chip and a second lens barrel; the twin lenses manual synchronous focusing structure includes:
a first thread inner hole defined in the first base and a first outer gear ring arranged on the first lens barrel, the first photosensitive chip is received in bottom of the first thread inner hole, and the first lens barrel is screwing connected with the first base;
a second thread inner hole defined in the second base and a second outer gear ring arranged on the second lens barrel; the second photosensitive chip is received in bottom of the second thread inner hole, and the second lens barrel is screwing connected with the second base;
a movable frame includes a first rack engaged with the first outer gear ring and a second rack engaged with the second outer gear ring; the first rack and the second rack are arranged at the same straight line;
a manual driving assembly connected to the movable frame, the manual driving assembly drives the movable frame to move between the center of the first lens barrel and the center of the second lens barrel along a straight line; the first rack drives the first outer gear ring to rotate, then the first lens barrel is moved close to or far from the first photosensitive chip; the second rack drives the second outer gear ring to rotate, then the second lens barrel is moved close to or away from the second photosensitive chip.

In some embodiments, the manual driving assembly includes a threaded barrel and a stud arranged at one end of the movable frame, and a return elastic element; the stud and the threaded barrel are screwing connected to push the movable frame straightly moving from the center of the first lens barrel to the center of the second lens barrel or from the center of the second lens barrel to the center of the first lens barrel; the return elastic element is arranged at an end of the movable frame away from the stud; when the movable frame moves towards the return elastic element, the return elastic element is compressed and has a restoring force.

In some embodiments, the movable frame includes a first frame, a connecting arm and a second frame, the first outer gear ring is located in the first frame, the first rack is formed in the first frame, the second outer gear ring is located in the second frame, the second rack is formed in the second frame.

In some embodiments, the twin lenses manual synchronous focusing structure further includes at least two guide posts arranged at intervals along the moving direction of the movable frame; wherein the movable frame defines at least one guide slot to march with the guide post, the guide slot and the guide posts are cooperated to restrict the linear movement of the movable frame.

In some embodiments, the guide slot is defined by a convex frame arranged on the upper side and/or the lower side of the movable frame.

In some embodiments, the number of the connecting arm is two, and the guide slot is defined by the two connecting arms arranged in parallel.

In some embodiments, the guide slot and the guide posts are cooperated to limit the moving route of the movable frame.

In some embodiments, one of the guide slots are defined, and the at least two guide posts are located in the same guide slot.

In some embodiments, a plurality of guide slots are defined along a straight line or in parallel, and at least one of the guide posts is received in each of the guide slots.

In some embodiments, the manual driving assembly includes a rotating gear; a third rack engaged with the rotating gear is arranged on the movable frame; the third rack, the second rack, the first rack are arranged in parallel.

In some embodiments, the movable frame includes a first frame, a connecting arm and a second frame, the first outer gear ring is located in the first frame, the first rack is formed in the first frame, the second outer gear ring is located in the second frame, the second rack is formed in the second frame.

In some embodiments, the twin lenses manual synchronous focusing structure further includes at least two guide posts arranged at intervals along the moving direction of the movable frame; wherein the movable frame defines at least one guide slot to march with the guide post, and the guide slot and the guide posts are cooperated to restrict the linear movement of the movable frame.

In some embodiments, the guide slot is defined by a convex frame arranged on the upper side and/or the lower side of the movable frame.

In some embodiments, the number of the connecting arm is two, one of the connecting arms is arc-shaped and the other is a straight strip-shaped, the third rack is arranged on the connecting arm with straight strip-shape; the guide slot is defined by the two connecting arms.

In some embodiments, the guide slot and the guide posts are cooperated to limit the moving route of the movable frame.

In some embodiments, one of the guide slots are defined, and the at least two guide posts are located in the same guide slot.

In some embodiments, a plurality of guide slots are defined along a straight line or in parallel, and at least one of the guide posts is received in each of the guide slots.

In some embodiments, the camera device further includes a light filling unit arranged between the first lens assembly and the second lens assembly, a relief hole is defined on the movable frame, the light filling unit is received in the relief hole and maintains spaced with the movable frame.

In some embodiments, the camera device includes a housing assembly, the housing assembly comprises a lens cover and a body, the lens cover and the body form a housing chamber to accommodate the first lens assembly, the second lens assembly, the movable frame, and the second lens assembly; a limit slot corresponding to the movable frame is defined on the lens cover.

In some embodiments, a camera equipment includes:
a camera device, including a first lens assembly and a second lens assembly spaced arranged with the first lens assembly; the first lens assembly including a first base, a first photosensitive chip and a first lens barrel; the second lens assembly including a second base, a second photosensitive chip and a second lens barrel;
a twin lenses manual synchronous focusing structure, including:
   a first thread inner hole defined in the first base and a first outer gear ring arranged on the first lens barrel, the first photosensitive chip is received in bottom of the first thread inner hole, and the first lens barrel is screwing connected with the first base;
   a second thread inner hole defined in the second base and a second outer gear ring arranged on the second lens barrel; the second photosensitive chip is received in bottom of the second thread inner hole, and the second lens barrel is screwing connected with the second base;
   a movable frame including a first rack engaged with the first outer gear ring and a second rack engaged with the second outer gear ring; the first rack and the second rack is arranged at the same straight line;
   a manual driving assembly connected to the movable frame, the manual driving assembly drives the movable frame to move between the center of the first lens barrel and the center of the second lens barrel along a straight line; the first rack drives the first outer gear ring to rotate, then the first lens barrel is moved close to or far from the first photosensitive chip; the second rack drives the second outer gear ring to rotate, then the second lens barrel is moved close to or away from the second photosensitive chip.

The present disclosure has the following beneficial effects: the twin lenses manual synchronous focusing structure provided by the present disclosure can drive the movable frame to move through the manual driving assembly during focusing, while the first rack on the movable frame drives the first outer gear ring to rotate, the second rack drives the second outer gear ring to rotate, the first outer gear ring turns the first lens barrel to rotate, and the first lens barrel is screwing connected with the first base, thus, the first lens barrel is moved close to or far away from the first photosensitive chip, the second outer gear ring turns the second lens barrel to rotate, and the second lens barrel is screwing connected with the second base, thus the second lens barrel is moved close to or far from the second photosensitive chip, so that the focusing of the first lens assembly and the second lens assembly can be synchronized. Moreover, the rack and gear ring are cooperated and then the rotation is converted to linear movement through thread, and the focusing precision is high.

### DRAWINGS DESCRIPTION

FIG. 1 is a schematic diagram of the exploded structure of the twin lenses manual synchronous focusing structure in example 1 of the present disclosure;

FIG. 2 is a schematic diagram of the outline structure of the twin lenses manual synchronous focusing structure in example 1 of the present disclosure;

FIG. 3 is a schematic diagram of the structure of the twin lenses manual synchronous focusing structure removing the lens caps in example 1 of the present disclosure;

FIG. 4 is a schematic diagram of the structure of a twin lenses manual synchronous focusing structure removing the main body in example 1 of the present disclosure;

FIG. 5 is a schematic diagram of the exploded structure of the twin lenses manual synchronous focusing structure in example 2 of the present disclosure;

FIG. 6 is a schematic diagram of the outline structure of the twin lenses manual synchronous focusing structure in example 2 of the present disclosure;

FIG. 7 is a schematic diagram of the structure of the twin lenses manual synchronous focusing structure removing the lens caps in example 2 of the present disclosure;

FIG. 8 is a schematic diagram of the structure of a twin lenses manual synchronous focusing structure removing the main body in example 2 of the present disclosure;

### DETAILED DESCRIPTION

In order to more clearly describe the purpose, the technical scheme and the advantages of the present disclosure, a twin lenses manual synchronous focusing structure of the present disclosure is further described in detail below with reference to the accompanying drawings and embodiments. It should be understood that the specific embodiments described herein are only used to explain the present disclosure and do not limit the scope of protection of the present disclosure.

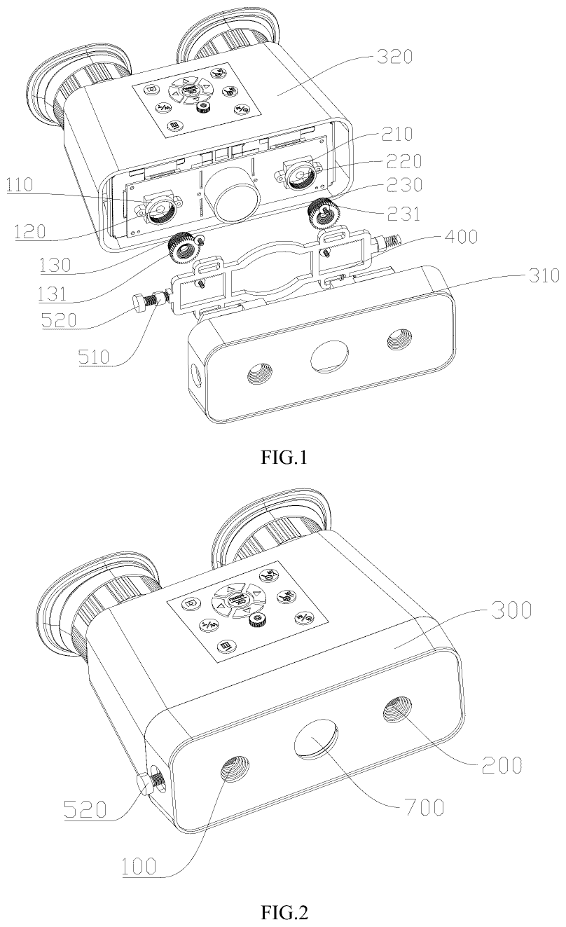

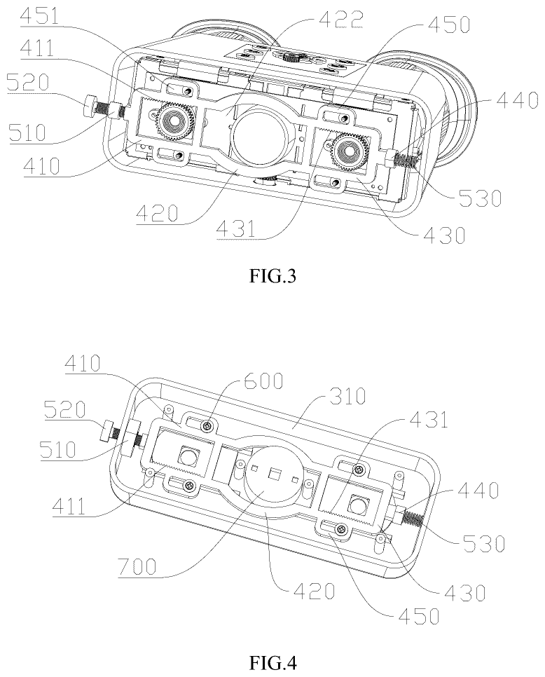

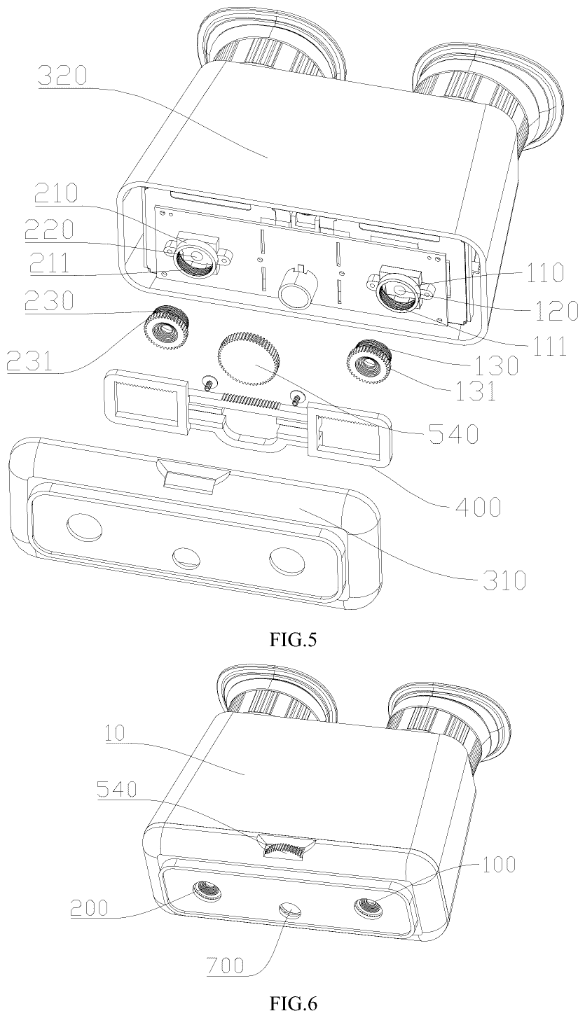

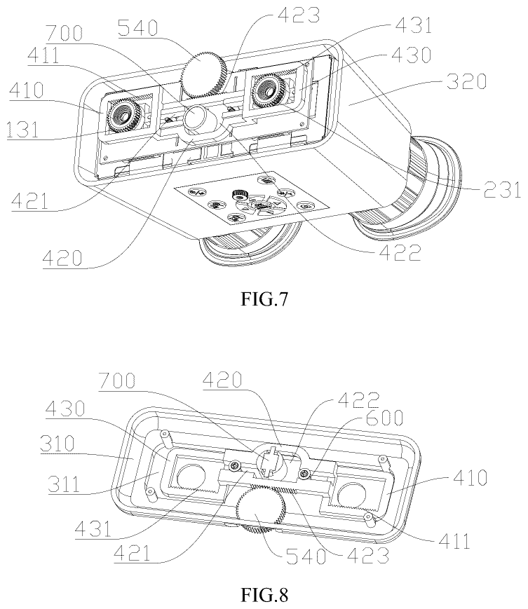

As shown in FIG. 1 to FIG. 8, a twin lenses manual synchronous focusing structure, used on a camera device 10. The camera device 10 includes a first lens assembly 100 and a second lens assembly 200 spaced arranged. The first lens assembly 100 comprises a first base 110, a first photosensitive chip 120 and a first lens barrel 130. The second lens assembly 200 includes a second base 210, a second photosensitive chip 220 and a second lens barrel 230.

The twin lenses manual synchronous focusing structure includes a first thread inner hole 111 defined in the first base 110 and a first outer gear ring 131 arranged on the first lens barrel 130. The first photosensitive chip 120 is received in bottom of the first thread inner hole 111, and the first lens barrel 130 is screwing connected with the first base 110.

The twin lenses manual synchronous focusing structure further includes a second thread inner hole 211 defined in the second base 210 and a second outer gear ring 231 arranged on the second lens barrel 230. The second photosensitive chip 220 is received in the second thread inner hole 221, and the second lens barrel 230 is screw connected with the second base 210.

The twin lenses manual synchronous focusing structure further includes a movable frame 400. The movable frame includes a first rack 411 engaged with the first outer gear ring 131 and a second rack 431 engaged with the second outer gear ring 231. The first rack 411 and the second rack 431 are arranged at the same straight line.

The twin lenses manual synchronous focusing structure further includes a manual driving assembly 500. The movable frame 400 is connected to the manual driving assembly 500. The manual driving assembly 500 drives the movable frame 400 to move between the center of the first lens barrel and the center of the second lens barrel along a straight line, that is from the center of the first lens barrel 130 to the center of the second lens barrel 230 or from the center of the second lens barrel 230 to the center of the first lens barrel 130 along a straight line. The first rack 411 drives the first outer gear ring 131 to rotate, then the first lens barrel 130 is moved close to or away from the first photosensitive chip 120. The second rack 431 drives the second outer gear ring 231 to rotate, and the second lens barrel 230 is moved close to or away from the second photosensitive chip 220.

During focusing, the manual driving assembly 500 drives the movable frame 400 to move, while the first rack 411 on the movable frame 400 drives the first outer gear ring 131 to rotate, the second rack 431 drives the second outer gear ring 231 to rotate. The first outer gear ring 131 turns the first lens barrel 130 to rotate, and the first lens barrel 130 is screw connected with the first base 110, thus the first lens barrel 130 is moved close to or away from the first photosensitive chip 120; the second outer gear ring 231 turns the second lens barrel 230 to rotate, and the second lens barrel 230 is screw connected with the second base 210, thus the second lens barrel 230 is moved close to or away from the second photosensitive chip 220; so that the focus of the first lens assembly 100 and the second lens assembly 200 can be synchronized. In addition, the first rack 411 drives the first outer gear ring 131 to rotate, and the second rack 431 drives the second outer gear ring 231 to rotate, both of which are coordinated with the rack and gear ring and then the rotation is converted into linear movement through screw threads, and the focusing precision is further improved.

Referring to FIG. 1 to FIG. 4, the manual driving assembly 500 includes a threaded barrel 510, a stud 520 and a return elastic element 530. The threaded barrel 510 and the stud 520 are arranged at an end of the movable frame 400, and the return elastic element 530 is arranged at an opposite end of the movable frame 400. The stud 520 and the threaded barrel 510 are screw connected to push the movable frame 400 straightly moving between the center of the first lens barrel 130 and the center of the second lens barrel 230 along a straight line, that is from the center of the first lens barrel 130 to the center of the second lens barrel 230 or form the center of the second lens barrel 230 to the center of the first lens barrel 130. The return elastic element 530 is arranged on the end of the movable frame 400 away from the stud 520. When the movable frame 400 moves towards the return elastic element 530, the return elastic element 530 is compressed and has a restoring force. It is understood that the stud 520 is exposed from a housing assembly 300 of the camera device 10 for manual adjustment, and the threaded barrel 510 is fixed to or directly formed by the housing assembly 300, and the fixed type may be welded connection or limit nesting connection. The stud 520 is not connected to the movable frame 400, that is, when the movable frame 400 moves towards the return elastic element 530, the stud 520 is in contact with the movable frame 400, and if need to move the movable frame 400 away from the return elastic element 530, the stud 520 can be loosen, then the return elastic element 530 can push the movable frame 400 moving under the action of restoring force. Preferably, a mounting cylinder 440 adapted to the return elastic element 530 is arranged on the movable frame 400, and simply, the return elastic element 530 is a spring. Alternatively, as another embodiment of the present disclosure, referring to FIG. 5 to FIG. 8, the manual driving assembly 500 includes a rotating gear 540, a third rack 423 engaged with the rotating gear 540 is arranged on the movable frame 400, and the third rack 423, the second rack 431, and the first rack 411 are arranged in parallel. That is, the manual driving assembly 500 also adopts the mode of tooth meshing, a part of the rotating gear 540 is exposed from the housing assembly 300, a central shaft is arranged in the middle of the rotating gear 540, the rotating gear 540 can be movably connected with the central shaft, in particular, a bearing can be arranged between the central shaft and the rotating gear 540 to facilitate rotation, or, the rotating gear 540 is fixed connected to the central shaft, the central shaft is movable connected to the housing assembly 300, and bearings can be arranged on the two ends of the central shaft for rotating the central shaft. Preferably, the third rack 423 is directly formed on a connecting arm 420.

Please refer to FIGS. 1, 3, 4, 5, 7 and 8, the movable frame 400 includes a first frame 410, a connecting arm 420 and a second frame 430. The first outer gear ring 131 is located in the first frame 410, the first rack 411 is formed in the first frame 410, and the second outer gear ring 231 is located in the second frame 430, the second rack 431 is formed in the second frame 430. The number of the connecting arm 420 can be more than one to improve the stability of the connection between the first frame 410 and the second frame 430. In general, the first frame 410 and the second frame 430 are located in the same plane, and the connecting arm 420 can be located in the same plane with the first frame 410 and the second frame 430 or can be not located in the same plane with the first frame 410 and the second frame 430. Using the movable frame 400 can improve the stability of the twin lenses manual synchronous focusing structure, and can ensure the first lens assembly and the second lens assembly synchronization, avoid the failure caused by the sloping of one end.

Refer to FIGS. 1, 3, 4, 5, 7 and 8, the twin lenses manual synchronous focusing structure further includes at least two guide posts 600 arranged at intervals along the moving direction of the movable frame 400. The movable frame 400 defines at least one guide slot 421/451 to march with the guide posts 600. The guide slot 421/451 and the guide posts 600 are cooperated to restrict the linear movement of the movable frame 400. Simply, a guide slot 421/451 can be defined, and the at least two guide posts 600 are located in the same guide slot 421/451. Alternatively, a plurality of guide slots 421/451 may be defined, the plurality of guide slots 421/451 can be defined along a straight line or in parallel, and at least one of the guide posts 600 is received in each guide slot 421/451.

Preferably, the guide slot 421/451 and the guide posts 600 are cooperated to limit the moving route of the movable frame 400. That is, the length of the guide slot 421/451 limits the moving route of the movable frame 400.

Refer to FIG. 1 to FIG. 4, the guide slot 421/451 is defined by convex frames 450 arranged on the upper side and/or lower side of the movable frame 400. In general, the guide slots 421/451 are defined on the upper side and lower side of the first frame 410 and the second frame 430. In general, in order to ensure the stability of the moving, a symmetrical structure can be adopted. Alternatively, refer to FIGS. 5-8, as shown in another embodiment of the present disclosure, the guide slots 421/451 are defined by two parallel and spaced connecting arms 420. It is understood that the guide slots 421/451 can be defined directly by the connecting arm 420, or slides for defining the guide slots 421/451 can be arranged on the connecting arm 420, and the slides can be connected to the connecting arm 420 by bonding, welding, etc.

Refer to FIG. 1 to FIG. 8, the camera device 10 also includes a light filling unit 700 arranged between the first lens assembly 100 and the second lens assembly 200. A shelter hole 422 is defined on the movable frame 400, and the light filling unit 700 is received in the shelter hole 422 and is maintained spacing from the movable frame 400. That is, the length of the relief hole 422 on the moving direction of the movable frame 400 is greater than the moving distance of the movable frame 400. The light filling unit 700 cooperated to the first lens assembly 100 and the second lens assembly 200 can be used for night vision observation, and the light filling unit 700 can be low light or infrared light as required.

Refer to FIG. 1 to FIG. 8, the camera device 10 includes the housing assembly 300. The housing assembly 300 includes a lens cover 310 and a body 320, and the lens cover 310 and the body 320 form a housing chamber for mounting the first lens assembly 100, the second lens assembly 200 and the movable frame 400. A limit slot 311 corresponding to the movable frame 400 is defined on the lens cover 310. The linear movement of the movable frame 400 can be further guaranteed through the limit slot 311.

Preferably, the first lens assembly 100 and the second lens assembly 200 are spaced with pupil distances to take a naked-eye 3D picture.

### Example 1

Refer to FIG. 1 to FIG. 4, a housing assembly 300 of a camera device 10 includes a body 320 and a lens cover 310. The lens cover 310 and the body 320 form a housing chamber. A first lens assembly 100, a second lens assembly 200 and a movable frame 400 are received in the housing chamber. A light filling unit 700 is arranged between the first lens assembly 100 and the second lens assembly 200.

The first lens assembly 100 includes a first base 110, a first photosensitive chip 120 and a first lens barrel 130. The first base 110 and the first lens barrel 130 are threaded together. The first photosensitive chip 120 is located in the first base 110, and a first outer gear ring 131 is arranged on the first lens barrel 130.

The second lens assembly 200 includes a second base 210, a second sensitive chip 220 and a second lens barrel 230. The second base 210 and the second lens barrel 230 are threaded together. The second sensitive chip 220 is located in the second base 210, and a second outer gear ring 231 is arranged on the second lens barrel 230.

The movable frame 400 includes a first frame 410, a connecting arm 420 and a second frame 430. The first frame 410 is arranged outside of the first lens assembly 100, the second frame 430 is arranged outside of the second lens assembly 200. A first rack 411 is formed on the first frame 410, and the first rack 411 is engaged with the first outer gear ring 131. A second rack 431 is formed on the second frame 430, and the second rack 431 is engaged with the second outer gear ring 231. The number of the connecting arms 420 is two, there has two curved arms, and the light filling unit 700 is located between the two curved arms and maintains spaced with the curved arms. A convex frame 450 is arranged on each of the upper side and lower side of the first frame 410 and the second frame 430 respectively. A guide slot 451 is defined on each of the convex frames 450. A guide post 600 is arranged on and screwing connected to the lens cover 310 to avoid the guide post 600 detaching from the guide slot 451 when the movable frame 400 moves.

The manual driving assembly 500 includes a stud 520 and a threaded barrel 510 on one end of the movable frame 400, and a return elastic element 530 on the other end. The threaded barrel 510 is fixed to the lens cover 310, and the return elastic element 530 is limited by a mounting barrel 440 on the movable frame 400.

### Example 2

Refer to FIG. 5 to FIG. 8, the different between Example 1 and Example 2 are that the movable frame 400 in Example 2 uses different manual drivers and different structures.

In Example 2, the movable frame 400 also includes a first frame 410, a connecting arm 420 and a second frame 430, the differences are that a guide slot 421 is defined on the connecting arm 420 at each of the two opposite sides of the relief hole 422. A guide post 600 is arranged in each of the guide slots 421. The number of the connecting arms 420 is two, one of the connecting arms 420 is arc-shaped and the other is a straight strip-shaped. The third rack 423 is arranged on the connecting arm 420 with straight strip-shape, and the arc-shaped connecting arm 420 is used to define the relief hole 422.

The differences further includes: the manual driving assembly 500 includes a third rack 423 located on one of the connecting arms 420, and a rotating gear 540 engaged with the third rack 423 is exposed from the lens cover 310.

It should be noted that if the embodiments of the present disclosure involve directional indications (such as up, down, first, second, front, back . . . ), the directional indication is only used to explain the relative position relationship and motion between the components under a specific attitude (as shown in the attached figure). If the specific attitude changes, the directional indication will change accordingly.

In summary, the twin lenses manual synchronous focusing structure provided by the present disclosure can drive the movable frame to move through the manual driving assembly during focusing, while the first rack on the movable frame drives the first outer gear ring to rotate, the second rack drives the second outer gear ring to rotate, the first outer gear ring turns the first lens barrel to rotate, and the first lens barrel is screwing connected with the first base, thus, the first lens barrel is moved close to or far away from the first photosensitive chip, the second outer gear ring turns the second lens barrel to rotate, and the second lens barrel is screwing connected with the second base, thus the second lens barrel is moved close to or far from the second photosensitive chip, so that the focusing of the first lens assembly and the second lens assembly can be synchronized. Moreover, the rack and gear ring are cooperated and then the rotation is converted to linear movement through thread, and the focusing precision is high.

The above is only a better embodiment of the present disclosure and is not intended to limit the present disclosure in any form. Although the present disclosure has been disclosed as a better embodiment, it is not intended to limit the present disclosure. Any technical person familiar with the profession, within the scope of the technical scheme of the present disclosure, can use the technical content disclosed above to make some changes or modifications into equivalent embodiments of equivalent changes, but any simple modifications, equivalent changes and modifications to the above embodiments that are not removed from the technical scheme of the present disclosure and based on the technical essence of the present disclosure are still within the scope of the technical scheme of the present disclosure.

1-9. (canceled)

10-19. (canceled)

20. A camera equipment, comprising:
a camera device, comprising a first lens assembly and a second lens assembly spaced arranged with the first lens assembly; the first lens assembly comprising a first base, a first photosensitive chip and a first lens barrel; the second lens assembly comprising a second base, a second photosensitive chip and a second lens barrel; and
a twin lenses manual synchronous focusing structure, comprising:
a first thread inner hole defined in the first base and a first outer gear ring arranged on the first lens barrel, the first photosensitive chip being received in bottom of the first thread inner hole, and the first lens barrel being screwing connected with the first base;
a second thread inner hole defined in the second base and a second outer gear ring arranged on the second lens barrel; the second photosensitive chip being received in bottom of the second thread inner hole, and the second lens barrel being screwing connected with the second base;
a movable frame comprising a first rack engaged with the first outer gear ring and a second rack engaged with the second outer gear ring; the first rack and the second rack being arranged at the same straight line; and
a manual driving assembly connected to the movable frame, the manual driving assembly driving the movable frame to move between the center of the first lens barrel and the center of the second lens barrel along a straight line; the first rack driving the first outer gear ring to rotate, then the first lens barrel being moved close to or far from the first photosensitive chip; the second rack driving the second outer gear ring to rotate, then the second lens barrel being moved close to or away from the second photosensitive chip; and wherein
the manual driving assembly comprises a threaded barrel and a stud arranged at one end of the movable frame, and a return elastic element; the stud and the threaded barrel are screwing connected to push the movable frame straightly moving from the center of the first lens barrel to the center of the second lens barrel or from the center of the second lens barrel to the center of the first lens barrel; the return elastic element is arranged at an end of the movable frame away from the stud; when the movable frame moves towards the return elastic element, the return elastic element is compressed and has a restoring force; and wherein
the movable frame comprises a first frame, a connecting arm and a second frame, the first outer gear ring is located in the first frame, the first rack is formed in the first frame, the second outer gear ring is located in the second frame, the second rack is formed in the second frame; and wherein
the first frame and the second frame are located in the same plane, and the connecting arm are located in the same plane with both the first frame and the second frame or can be located in a plane that is different from that of both the first frame and the second frame; and wherein
the camera device further comprises a light filling unit arranged between the first lens assembly and the second lens assembly, a relief hole defined on the movable frame, the light filling unit received in the relief hole and maintains spaced with the movable frame; and wherein
a length of the relief hole on a moving direction of the movable frame is greater than a moving distance of the movable frame; and wherein
the number of the connecting arms is two, and the two connecting arms are two curved arms, the light filling unit located between the two curved arms and maintains spaced with the two curved arms.

21-23. (canceled)
